(19) United States
(12) Patent Application Publication
(10) Pub. No.: US 2006/0180600 A1
(43) Pub. Date: Aug. 17, 2006

(54) Automated prescription reminder, dispenser, and monitor

(76) Inventor: Shannon Talyor, Hoover, AL (US)

Correspondence Address: LANIER FORD SHAVER & PAYNE, P O BOX 2087, HUNTSVILLE, AL, 35804, US

(21) Appl. No.: 11/311,040

(22) Filed: Dec. 19, 2005

Related U.S. Application Data
(60) Provisional application No. 60/637,803, filed on Dec. 21, 2004.

(51) Int. Cl. G07F 11/00

(52) U.S. Cl. 221/87

(57) ABSTRACT

A medication dispensing device is provided. The device has a storage compartment which stores the user's medication, a programming means whereby a caregiver can input dosage schedules and dosage instructions, and a display which shows the users dosage information. The device can be equipped with communication devices which will allow caregivers to monitor dosing schedules and dosage levels.

### REFERENCE TO RELATED APPLICATIONS

This application claims priority to Provisional Patent Application U.S. Ser. No. 60/637,803, entitled “Automated Prescription Reminder, Dispenser, and Monitor,” and filed on Dec. 21, 2004, which is fully incorporated herein by reference.

### FIELD OF THE INVENTION

The present invention relates generally to health care. In particular, the present invention relates to dispensing medication, reminding patients to take medication, and monitoring the status of dispensed medication. More particularly, the invention relates to a device for accomplishing these tasks.

### BACKGROUND OF THE INVENTION

The effectiveness of medication is significantly reduced when patients fail to comply with the prescribed dosing schedule. Doctors and caregivers must rely on patients to take their medication at the appropriate times and pursuant to the appropriate instructions. Doctors cannot properly measure the efficacy of a prescription medication or its dosage when the patient does not take the medication as prescribed. Patients may not inform their doctors about missed or late doses. Dosages may be improperly changed if made in reliance on inaccurate medication information. Furthermore, a significant factor in determining whether a patient should be placed into a nursing care facility involves a decision on whether the patient can properly take his or her medication.

In most cases, the burden of taking medication at the prescribed time falls to the patient or his or her family. This burden can become very difficult for elderly patients and for patients in poor health that must keep up with several medications and their associated dosing schedules, special instructions, and missed dosage restrictions. Some of the devises that are currently available to assist patients with these problems are of the plastic compartment type and are inexpensive and not as helpful or versatile as the present invention. Others that currently exist are large and bulky and can be quite expensive. Furthermore, they lack the ability to alert patients of specific instructions associated with taking the medication, whether it be at the prescribed time, or as a result of a missed dosage. Finally, many of the current devises are unable to monitor the user's medication performance, and are unable to alert a third party should any dosages be missed. The present invention addresses each of these problems and will ensure compliance with any and all medication requirements.

### SUMMARY OF THE INVENTION

The present disclosure is directed to a device for dispensing medication, reminding patients to take their medication, and monitoring the status of dispensed medication. This is accomplished by providing a hand held electronic device that sounds an alarm to remind the user that there is a dose of medication due to be dispensed and taken by the user. This device stores a user's medications and dispenses the medication according to the prescribed dosing schedule.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

The present invention discloses a handheld electronic device which reminds the user when there is a dose of medication due to be dispensed and taken by the user and displays the medication's associated instructions. The device stores a user's medication and will signal the user to dispense the medication according to the prescribed dosing schedule. The device can accommodate multiple medications and multiple dosing schedules. The device can be equipped to perform several other unique functions. For example, the device can also be equipped to monitor the user's compliance with the prescribed dosing schedule, and alert others should the user fail to comply with dosage requirements. Furthermore, the device can display special instructions associated with different medications. Its audible alarm can be a spoken alarm, increasing in volume and frequency until the medication is dispensed. It can also notify the appropriate pharmacy or doctor when the medication needs to be refilled, or when the medication has been fully dispensed. The present invention can store the user's compliance with the prescribed medication schedule and provide such information to the supervising caregiver.

These and other embodiments of the present invention will also become readily apparent to those skilled in the art from the following detailed description of the embodiments having reference to the attached figures, the invention not being limited to any particular embodiment(s) disclosed.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 is an exemplary handheld medication dispensing device;

FIG. 2A is a top plan view of an exemplary storage unit for use with the handheld medication dispensing device;

FIG. 2B is a perspective view of an exemplary storage unit for use with the handheld medication dispensing device;

FIG. 3 is a perspective view of an exemplary storage unit that has the bottom and top portions separated.

### DETAILED DESCRIPTION

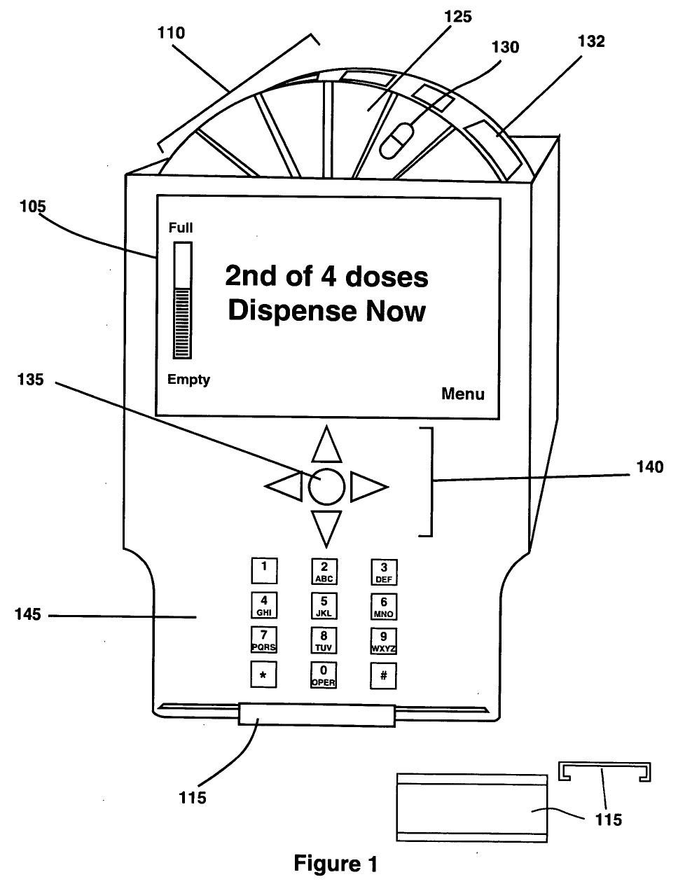

The various embodiments of the present invention and their advantages are best understood by referring to FIGS. 1 through 3 of the drawings. The elements of the drawings are not necessarily to scale, emphasis instead being placed upon clearly illustrating the principles of the invention. Throughout the drawings, like numerals are used for like and corresponding parts of the various drawings.

Referring now to FIG. 1, a handheld medication dispensing device contains a display means 105, a storage means 110, and a programming means 145. The display means 105 can display dosage information such as which dose the user is on (“2 of 4”), and also any special instructions associated with the medication (“Take with food,” “Take 2 hours before bedtime,” etc.). Furthermore, the display means 105 can indicate the amount of medication remaining to be dispensed in order for the user to know when the device needs to be recharged or refilled. Finally, the display means provides a link to the menu so that the user may change alarm settings, dosage requirements, and other general settings according to the user's preference.

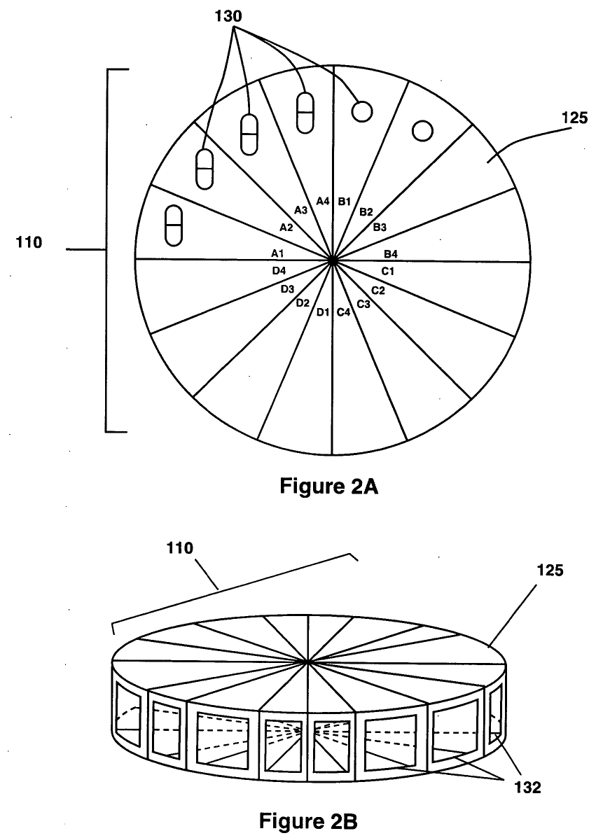

The storage means 110 (of FIGS. 1 and 2) is composed of bins 125 which contain the medication or vitamin due to be dispensed. The storage means 110 can contain a different number of bins depending on the needs of the user. Each bin is charged or filled with medication according to its prescribed schedule. For example, referring to FIG. 2A, doses due to be taken 4 times a day can be placed in the bins 125 with the prefix A. Medication taken twice a day can be placed in the bins 125 with the prefix B. In the preferred embodiment, the storage means 110 can hold one day's worth of medication. At the end of the day, the user needs only to replace the empty storage means with a full one.

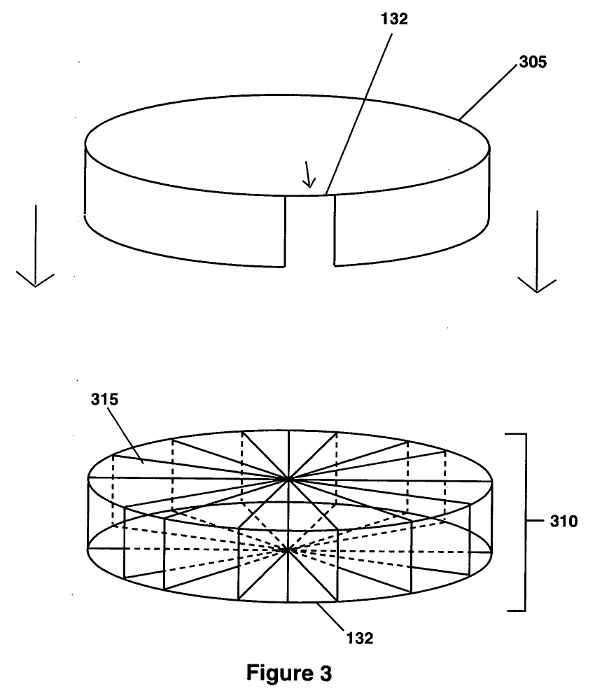

Referring now to FIG. 3, the storage means can be charged or filled by removing the top portion 305 from the bottom portion 310. The bottom portion contains dividing partitions 315 which form the bins 125. Once the medication has been entered into its respective bin, the top portion 305 can be lowered onto the bottom portion 310 and the storage means 110 can be placed in its receptacle on the device. If necessary, several receptacles can be provided for users who do not want to load a new charged storage means each day.

The medication 130 is dispensed when its respective bin rotates over the dispensing channel wherein gravity causes the medication to travel through the bin door 132 and into the dispensing channel (not shown) located inside the devise. After traveling down the dispensing chamber, the medication exits the device through the dispensing door 115. Rotation of the bins is caused when the user, after being alerted according to a preset dosing schedule, depresses the dispensing button 135 in the center of the arrow pad 140.

The programming means 145 allows the user to input all necessary information relating to dosage schedules, special dosing instructions, missed dosage instructions, alarm settings, and monitoring settings. In the preferred embodiment shown in FIG. 1, the programming means 145 is accomplished through a keypad. The user responsible for charging or filling the unit (i.e., a physician, pharmacist, caregiver, or patient) keys in dosing information corresponding to the medication in each bin 125. In the preferred embodiment, the dosing information is selected from on-screen menus according to preset information using the keypad 145 or the arrow pad 140.

The device can be equipped with sensors, communication devices, speakers, locking mechanisms, and linking devices which are not shown but will be obvious to one skilled in the art. Sensors can be used to detect whether or not a particular dosage has been taken or whether the user has depressed the dispensing button 135. If the user has not taken the medication at the appropriate time, the device can lock itself to ensure that the designated caregiver is notified and the proper missed dosage instructions are followed.

Communication devices can wirelessly transmit the device's stored information such as the amount of medication dispensed, the amount of medication due to be dispensed, and the schedule which has been followed for any particular medication. Such information can be transmitted to the user's physician, pharmacist, caregiver, or family member via fax, e-mail, text message, phone, internet, pager, or other available communication mediums.

An on-board speaker can be used to audibly alert the user when a dose is due to be dispensed. Locking mechanisms can prevent both the patient and any other unauthorized user from tampering with the device's programming or medication. Finally, linking devices, such as a serial, parallel, or Universal Serial Bus (USB) port, can allow the medication dispenser to be attached to a personal computer or other electronic device for easy programming and data collection. The device may also transmit its data to a website for remote access by authorized caregivers. Users can access account information to see which medication was dispensed, when it was dispensed and what is remaining to be dispensed.

The device can be set up for two classes of users: the patient and the charger, or filler. If the patient is unfamiliar with electronics, then he or she will only be allowed to dispense medication by pressing the dispensing button 135 at the appropriate time. The charger on the other hand will have full access to program and load the device to ensure that the proper dosing schedule and instructions are available for the appropriate medication.

This invention may be provided in other specific forms and embodiments without departing from the essential characteristics as described herein. The embodiments described above are to be considered in all aspects as illustrative only and not restrictive in any manner. The following claims rather than the foregoing description indicate the scope of the invention.

As described above and shown in the associated drawings, the present invention comprises an automated device for dispensing medication. While particular embodiments of the invention have been described, it will be understood, however, that the invention is not limited thereto, since modifications may be made by those skilled in the art, particularly in light of the foregoing teachings. It is, therefore, contemplated by the appended claims to cover any such modifications that incorporate those features or those improvements that embody the spirit and scope of the present invention.

1. A medication dispensing device comprising:
a. a display;
b. a storage compartment;
c. a programming means;
d. a dispensing channel; and
e. a dispensing door,
wherein said medication dispensing device is programmed using said programming means to alert a user when a dose of medication is due to be taken, and wherein said dose is stored in said storage compartment and dispensed through said dispensing channel when directed by the user who retrieves said dose by activating said dispensing door.

2. The medication dispensing device of claim 1 further comprising a data storage means wherein said data storage means keeps track of which dose is dispensed and when said dose is dispensed.

3. The medication dispensing device of claim 1 further comprising a communication device wherein said data storage means can communicate with a caregiver of said user.

4. The medication dispensing device of claim 1 further comprising an alarm which alerts said user when a dose is due to be dispensed.

5. A medication dispensing device comprising:
a. a storage compartment;
b. a programming means;
c. a dispensing channel;
d. a dispensing door; and
e. a dispensing button;
wherein said medication dispensing device is programmed using said programming means to alert a user when a dose of medication is due to be taken in accordance with a dosing schedule, and wherein said dose is stored in said storage compartment and dispensed through said dispensing channel when directed by the user who retrieves said dose by displacing said dispensing door after activating said dispensing button.

6. The medication dispensing device of claim 5 further comprising a remote alarm which alerts said user when a dose is due to be dispensed.

7. The medication dispensing device of claim 6 wherein said alarm is an audible alarm emitted from a speaker disposed within said device.

8. The medication dispensing device of claim 5 further comprising a data storage means wherein said data storage means stores data such as said user's compliance with said dosage schedule, doses that are dispensed, or doses that are remaining to be dispensed.

9. The medication dispensing device of claim 8 further comprising a linking device wherein a charger of said device links said device to a personal computer for programming said programming means and for retrieving data from said data storage means.

10. The medication dispensing device of claim 8 further comprising a locking mechanism wherein said user is prevented from unauthorized access to said storage means.

11. The medication dispensing device of claim 10 wherein said locking mechanism prohibits user from unauthorized access to said programming means.

12. The medication dispensing device of claim 8 further comprising a communication device wherein data stored by said data storage means is communicated to an authorized recipient.

13. The medication dispensing device of claim 12 wherein said communication device transmits said data to said caregiver via one of the group consisting of a facsimile, electronic mail, or SMS (Short Message Service) text message.

14. A medication dispensing device comprising:
a. a display;
b. a storage compartment;
c. a programming means;
d. a dispensing channel;
e. a dispensing door;
f. a dispensing button;
g. an alarm;
h. a data storage means;
i. a locking mechanism; and
j. a communication device;
wherein said medication dispensing device is programmed using said programming means to alert a user with said alarm when a dose of medication is due to be taken in accordance with a dosing schedule, said dose is stored in said storage compartment and dispensed through said dispensing channel when directed by the user who retrieves said dose by displacing said dispensing door after activating said dispensing button, said data storage means stores said user's compliance with said dosage schedule said locking mechanism prevents said user from unauthorized access to said storage compartment and said programming means, and said communication device communicates data stored in said data storage means to an authorized recipient.

15. The medication dispensing device of claim 14 wherein said communication device transmits said data to said caregiver via one of the group consisting of a facsimile, electronic mail, or SMS (Short Message Service) text message.

16. The medication dispensing device of claim 14 further comprising a linking device wherein a charger of said device links said device to a personal computer for programming said programming means and for retrieving data from said data storage means.

17. A medication dispensing device comprising:
a. a display;
b. a storage compartment;
c. a programming means;
d. a dispensing channel;
e. a dispensing door;
f. a dispensing button; and
g. an alarm;
wherein said medication dispensing device is programmed using said programming means to alert a user with said alarm when a dose of medication is due to be taken in accordance with a dosing schedule, and wherein said dose is stored in said storage compartment and dispensed through said dispensing channel when directed by the user who retrieves said dose by displacing said dispensing door after activating said dispensing button.

18. The medication dispensing device of claim 17 wherein said alarm is a visual alarm emitted from said display.

19. The medication dispensing device of claim 17 wherein said display shows a dosage instruction associated with said dose that is due to be dispensed.

20. The medication dispensing device of claim 19 further comprising a data storage means wherein said data storage means monitors data such as said user's compliance with said dosage schedule, doses that are dispensed, or doses that are remaining to be dispensed.

21. The medication dispensing device of claim 20 further comprising a linking device wherein a charger of said device links said device to a personal computer for programming said programming means and for retrieving data from said data storage means.

22. The medication dispensing device of claim 20 further comprising a locking mechanism wherein said user is prevented from unauthorized access to said storage means.

23. The medication dispensing device of claim 20 further comprising a communication device wherein data stored by said data storage means is communicated to an authorized recipient.

24. The medication dispensing device of claim 23 wherein said communication device transmits said data to said caregiver via one of the group consisting of a facsimile, electronic mail, or SMS (Short Message Service) text message.
